(19) United States
(12) Patent Application Publication
(10) Pub. No.: US 2022/0277681 A1
(43) Pub. Date: Sep. 1, 2022

(54) DISPLAYS WITH IMAGE CAPTURING DEVICES

(71) Applicant: Hewlett-Packard Development Company, L.P., Spring, TX (US)

(72) Inventor: Lee Atkinson, Taipei City (TW)

(73) Assignee: Hewlett-Packard Development Company, L.P., Spring, TX (US)

(21) Appl. No.: 17/637,643

(22) PCT Filed: Nov. 14, 2019
(86) PCT No.: PCT/US2019/061404

§ 371 Date: Feb. 23, 2022

(51) Int. Cl. G09G 3/20; H04N 5/235

(52) U.S. Cl. CPC G09G 3/20; H04N 5/2354; G09G 2320/0626; G09G 2320/0686

(57) ABSTRACT

Examples for controlling refresh rates of a first portion of a display device integrated with an image capturing device located behind the display device, are described. The image capturing device is located behind the first portion. In an example, refresh rate of the first portion of the display area is controlled, such that the first portion periodically illuminates at a second refresh rate. The second refresh rate is such that it is less than a native refresh rate of the display device. Thereafter, operation of the image capturing device may be controlled, such that the image capturing device is to capture images between illumination of the first portion.

### BACKGROUND

Computing devices, such as desktops, laptops, mobiles phones, tablets, and handheld personal computers (PC) are generally coupled to a display device. Such display devices may be either connected to the computing device or may be integrated within such computing devices. In some cases, an image capturing device may be integrated and positioned behind a display screen of the display device.

### BRIEF DESCRIPTION OF THE DRAWINGS

The following detailed description references the drawings, wherein:

FIG. 1 illustrates a computing device for controlling illumination of a display device with an integrated image capturing device, according to an example;

FIG. 2 illustrates a display device with an integrated image capturing device, according to another example;

FIG. 3 illustrates a computing device within an example computing environment for controlling illumination of a display device with an integrated image capturing device, according to an example;

FIGS. 4-7 illustrates signals representing various states of illumination of a display device, according to an example;

FIG. 8 illustrates a method for controlling illumination of a display device with an integrated image capturing device, according to an example; and

FIG. 9 illustrates a non-transitory computer readable medium for controlling illumination of a display device with an integrated image capturing device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing device generally includes a display device for providing a visual output. Examples of such computing devices include, but are not limited to, a desktop, laptop, a tablet computer and a mobile phone. Such computing devices are provided with a display device, which may either be connected to the computing device through wired or wireless medium or may be integrated within the computing device itself. In certain such devices, an image capturing device may be positioned behind a display screen of the display device. Such display device with an integrated image capturing device may be used for network-based conferencing or video chat during which the image capturing device may be operational along with the display device of the computing device. The positioning of the image capturing device may be such that a user participating in the network-based conferencing appears to be viewing directly at the face of other participating users. An example of such an image capturing device may be include a camera unit or corresponding circuity which may capture an image when activated.

The display device may support a refresh rate which specifies the number of times a frame rendered onto the display area of the display device is refreshed or rendered. To this end, the display device may be periodically illuminated during which a frame may be rendered. Before the next frame may be rendered, the previous frame is removed, i.e., the display device is refreshed. The rate at which the frame is refreshed is referred to as refresh rate. In certain cases, a ‘black frame’ may be inserted during which the pixels of the display device may be turned off, to correct any blurring errors that may arise. For each frame, the time duration during which the display device remains illuminated may be predefined. In effect, the pixels of the display device may be periodically illuminated for a predefined time, and then switched off (to replicate a ‘black frame’). Such display devices are typically referred to as pseudo-impulse display devices.

In certain cases, the light emitted by pixels of the display may cause the images captured by the image capturing device to be saturated. For example, while both the image capturing device and the display device are in use, the display device may emit light which in turn may interfere with the image gathering capabilities of the image capturing device. To minimize interference that may be caused due to light emitted by surrounding pixels of the display screen, during the time period the display device is not illuminated (or in an OFF stage), the image capturing device is activated. The image capturing device captures a video in frames or images between the illumination of the display device and at a rate which matches the refresh rate of the display device. While the frames or images are captured, since the display device is not illuminated, the interference caused by it to the image capturing device is minimal.

The image capturing device, when activated, typically operates to capture about 30 frames per second which allows for an exposure time of about 30 milliseconds. However, modern emissive display devices may operate at a refresh rates of about 60 Hz, and in some cases, even at higher refresh rate. In the context of the present example, this causes the display devices to be illuminated every 16 milliseconds. As a result, the display device may be illuminated at instances while the image capturing device is operating. This may cause the images captured by the image capturing device to be saturated and hence impact the quality of the video shared amongst different participants during network-based conferencing. Such an issue may tend to be more pronounced in cases where the display device operates at higher refresh rates.

Example approaches for controlling illumination of a display device with an integrated image capturing device are described. In an example, a display area of the display device may include a first portion. The first portion may be an area of the screen of the display device behind which the image capturing device is positioned. As mentioned previously, the display device may be used for network-based conferencing. During normal operations, i.e., during periods when the display device is being used as a display for providing a visual output, the display device (including the first portion) may be illuminated for a duration at a native refresh rate of the display device. The native refresh rate of the display device may be understood as a default refresh rate of the display device during instances when the image capturing device is not active, in an example, the native refresh rate for the display device may be about 60 Hz or higher.

In another example, if the computing device is being used for applications such as network-based conferencing, the illumination of the first portion of the display device may be controlled such that the first portion periodically illuminates for the duration at a second rate. The second rate is so selected such that it is less than the native rate. In such examples, the first portion is refreshed at a reduced refresh rate, while the remainder of the display device (referred to as the second portion) is refreshed at the native rate. In an example, the second rate may be so selected such that it matches with a rate at which the image capturing device operates to capture images.

In operation, while the first portion is to operate at the second rate, when the first portion is illuminated and the image capturing device may be deactivated. Whereas in between the illumination of the first portion, i.e., when the first portion is not illuminated, the image capturing device may be active. Since the refreshing of the first portion is at a slower rate than the native refresh rate, a prolonged duration during which the first portion is not illuminated is available during which the image capturing device may be operated. As a result, the image capturing device does not experience any interference for prolonged intervals which may be present between the illumination of the first portion. It may be noted that even though the first portion is operating at a second refresh rate, the second portion continues to be operated at the native refresh rate. Since the slower refresh rate is applied to the first portion and the not the second portion, the quality of the visual output as a whole does not get impacted.

In an example, the slower second refresh rate may be affected by delaying or deleting alternate frames from series of frames which are to be rendered onto the first portion. In an example, the time duration for which the first portion is illuminated may be increased to compensate for any loss in brightness. In another example, the drive current for illuminating pixels corresponding to the first portion may be modulated or increased without increasing the time duration for which the first portion is illuminated to compensate against any decrease in brightness.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

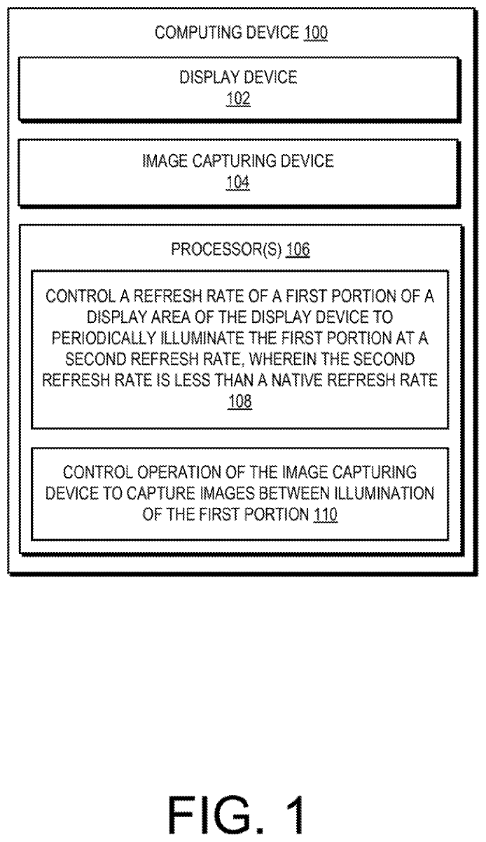

The manner in which the example computing devices are implemented are explained in detail with respect to FIGS. 1-5. While aspects of described computing devices can be implemented in any number of different electronic devices, environments, and/or implementations, the examples are described in the context of the following example system(s). It is to be noted that drawings of the present subject matter shown here are for illustrative purposes and are not to be construed as limiting the scope of the subject matter claimed.

FIG. 1 illustrates a computing device 100 for controlling illumination of a display device with an integrated image capturing device, according to an example. The computing device 100 may be a desktop computer, a laptop, a smartphone, a personal digital assistant (PDAs), and a tablet. In the example as illustrated, the computing device 100 may further include a display device 102 and image capturing device 104. The display device 102 may be integrated into the housing of the computing device 100 or may be connected to the computing device 100 through wireless or a wired connection. The display device 102 may be implemented as an LCD screen, an LED display screen, an organic LED (OLED) display screen, and the like. The display device 102 may operate a native refresh rate during which the display screen of the display device 102 may periodically illuminate for a predetermined period during which a frame may be rendered. In an example, the native refresh rate of the display device may be understood as a default refresh rate of the display device during instances when the image capturing device is not active. In an example, the native refresh rate for the display device may be about 60 Hz or higher.

The image capturing device 104 may be a camera which is positioned behind a first portion (not shown in FIG. 1) of the display device 102. In an example, the image capturing device 104 may be implemented as a complementary metal-oxide semiconductor (CMOS) camera. The first portion may be considered as an area being defined by a number of pixels spanning a portion of the display device 102. The shape and area of the first portion may vary. For example, the first portion may be a circular area of the display device 102 behind which the image capturing device 104 may be located. Although the present description may have been described in the context of one or more specific shapes, the shape of the first portion may vary without limiting the scope of the present subject matter.

Continuing with the present example, the computing device 100 may further include processor(s) 106 which may be in communication with the display device 102 and the image capturing device 104. The processor(s) 106 may be implemented as microprocessors, microcomputers, microcontrollers, digital signal processors, central processing units, state machines, logic circuitries, and/or any devices that manipulate signals based on operational instructions. Among other capabilities, the processor(s) 106 is configured to fetch and execute computer-readable instructions stored in a memory (not shown in FIG. 1), for example, in order to control illumination of the display device and to control operation of the image capturing device 104. In another example, the processor(s) 106 is to control illumination of the first portion of the display device 102 in a manner such that the first portion is operated at a second refresh rate which differs from the native refresh rate of the display device 102. The second refresh rate may be so selected such that it is less than the native refresh rate of the display device 102.

In operation, the processor(s) 106 may perform a series of functions, for example, in response to execution of one or more executable instructions provided within the computing device 100. For example, the processor(s) 106 may control the refresh rate of the first portion of the display device 102. The refresh rate of the first portion is controlled in a manner which causes the first portion to be illuminated periodically and at the second refresh rate (represented as block 108). in an example, the second refresh rate is less than the native refresh rate of the display device 102. In another example, in the event that the image capturing device 104 is not activated, both the first portion and the second portion of the display device 102 may be refreshed at the same native refresh rate. However, in the event that the image capturing device 104 is activated, the refresh rate of the first portion is refreshed at the second refresh rate, while the second portion of the display device 102 continues to be refreshed at the native refresh rate. These and other aspects are further described in detail.

The processor(s) 106 may control the operation of the image capturing device 104. In an example, the processor(s) 106 may cause the image capturing device 104 to operate and capture images between instances when the first portion is periodically illuminated at the second refresh rate (represented as block 110).

While the first portion is refreshed at a slower rate, a prolonged duration during which the first portion is not illuminated is available during which the image capturing device 104 may be activated to capture images. Since the first portion is operated at a second rate, the illumination of the first portion does not cause any interference or saturations of the images captured by the image capturing device 104. In an example, the processor(s) 106 may activate the image capturing device 104 when certain applications are executed on the computing device 100. For example, the image capturing device 104 may be activated on the initiation of a network-based video conferencing applications, web-chats, or in response to a command from a user of the computing device 100.

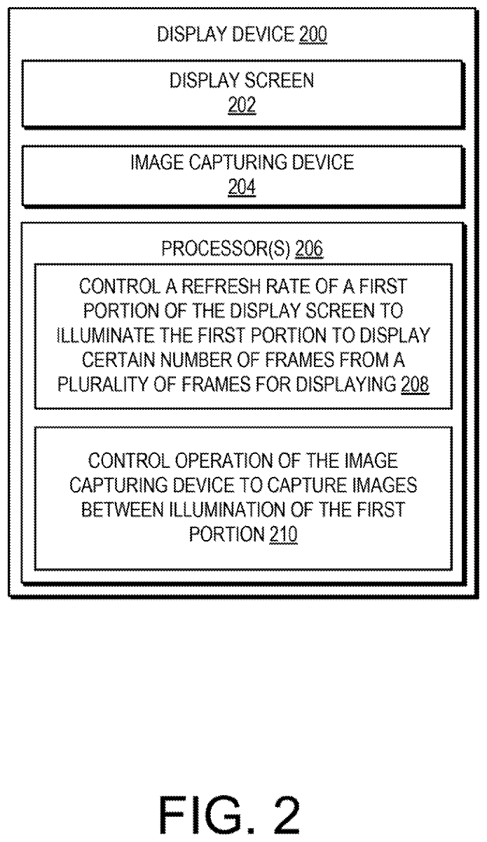

FIG. 2 illustrates a display device 200, according to another example. The display device 200 may include a display screen 202, an image capturing device 204 and a processor(s) 206. Examples of display screen 202 may include, but is not limited to, LCD screen, an LED display screen, and an organic LED display screen. The display screen 202 may further include a first portion. The first portion may be a portion of the display screen 202 behind which the image capturing device 204 may be located. The first portion may further include one or more pixels which are selectively controllable by the processor(s) 206 during operation of the display device 200. In an example, the image capturing device 204 may be integrated with the panel circuitry of the display screen 202. When a visual output is to be rendered, the processor(s) 206 is to cause a plurality of frames to be rendered into the display screen 202. To minimize any interference to the image capturing device 204 caused by the display screen 202, the first portion may be illuminated in a manner which differs from the remaining portion of the display screen 202 (referred to as the second portion).

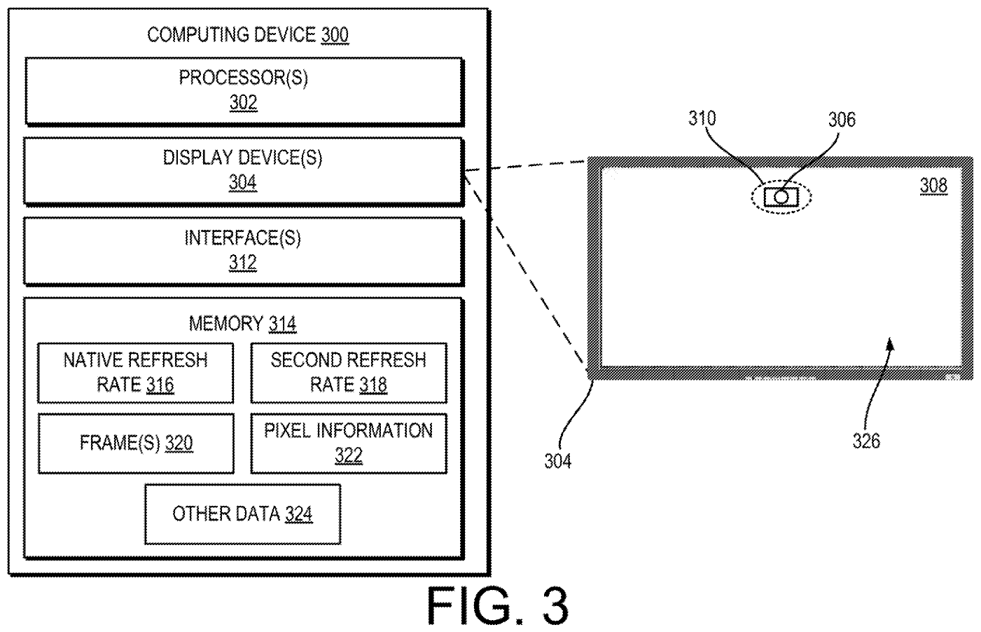

in operation, the processor(s) 206 is to control the periodic illumination of the first portion and the second portion of the display screen 202. When the image capturing device 204 is activated, the processor(s) 206 is to control the illumination of the first portion such that the first portion is illuminated to render a certain number of frames from amongst a plurality of frames (represented as block 208). For example, the processor(s) 206 may cause to render alternate frames from amongst the plurality of frames. In such a case, when such certain frames are to be rendered, the processor(s) 206 may illuminate corresponding pixels of the first portion. Since the first portion is illuminated periodically, but at a second refresh rate (which is less than the native refresh rate), a prolonged time interval is available during which the image capturing device 204 may be activated. As a result, the interference due to the illumination of the display screen 202 may be minimized. For example, the images captured by the image capturing device 204 may be free from saturation that may have been caused due the illumination of the display device 200 (represented as block 210). Also, controlling the refresh rate of the first portion at the second refresh rate ensures that the overall quality of the visual display rendered by the display device 200 is not impacted. This may also ensure that the images captured by the image capturing device 204 are also not prone to negative impacts that may be caused by the display device 200. It may be understood that the manner in which the refresh rate of the first portion is controlled may be affected through other examples without deviating from the scope of the present subject matter. These and other approaches are now described in further details in conjunction with example computing environment, illustrated in FIG. 3.

FIG. 3 illustrates a computing environment comprising a computing device 300. The computing device 300 may include a processor(s) 302 and a display device 304. In the present illustration, the logical block depicting the display device 304 is further expanded to illustrate an example display device 304. Continuing with the present example, the display device 304 may further include an image capturing device 306 which is located behind a display screen 308 of the display device 304. The display screen 308 may be further comprise a plurality of pixels (not visible in FIG. 3). Each of such pixels may be controlled by the processor(s) 302. In an example, the processor(s) 302 may selectively control a refresh rate of each of the pixels of the display device 304. During a refresh operation, one or more of the pixels may be illuminated at a native refresh rate which may be defined for the display device 304.

In the present example, the display device 304 may further include a first portion 310. The first portion 310 is such a portion behind which the image capturing device 306 may be located. The first portion 310 may be defined by a specific number of pixels behind which the image capturing device 306 may be located. Although depicted as elliptical, the first portion 310 may have different shapes without deviating from the scope of the present subject matter.

The computing device 300 may further include interface(s) 312 and memory 314. The interface(s) 312 may allow the connection or coupling of the computing device 300 with one or more other devices, through a wired (e.g., LAN) connection or through a wireless connection (e.g., Bluetooth®, WiFi). The interface(s) 312 may also enable intercommunication between different logical as well as hardware components of the computing device 300. The memory 314 may be implemented as a computer-readable medium known in the art including, for example, volatile memory (e.g., RAM), and/or non-volatile memory (e.g., EPROM, flash memory, etc.). The memory 314 may also be an external memory unit, such as a flash drive, a compact disk drive, an external hard disk drive, or the like. The memory 314 may include data which is either utilized and/or is generated during the operation of the computing device 300. In one example, the memory 314 may include information or values of configuration settings pertaining to the display device 304. For example, the memory 314 may include native refresh rate 316, a second refresh rate 318, frame(s 320, pixel information 322 and other data 324.

In operation, the processor(s) 302 is to control a refresh rate, i.e., the illumination of the first portion 310 and the remainder of the display screen 308, referred to as the second portion 326. The display device 304 may be considered as to operate in two modes depending on whether the image capturing device 306 is activated. In certain instances, the display device 304 may be used for providing a visual output when the image capturing device 306 may not be active. This may occur when the computing device 300, and in turn the display device 304, is used for displaying or playing back a video. During such uses, the processor(s) 302 is to operate the display device 304 (including the first portion 310) at a refresh rate which is based on the native refresh rate 316. While refreshing the display device 304, the processor(s) 302 is to periodically illuminate the display device 304 at the native refresh rate 316 by controlling the illumination of the pixels of the display device 304. To this end, the processor(s) 302 may communicate control signals through one or more drivers driving the pixels. In response to the control signals, the pixels of the display device 304 may be periodically illuminated or switched off based on the native refresh rate 316.

However, in a second mode when image capturing device 306 is activated, the processor(s) 302 may initially determine the position of the first portion 310 with respect to the display screen 308 of the display device 304. For example, the image capturing device 306 may be activated during execution of certain network-based conferencing applications, e.g., a video chat or a video conference. In an example, the processor(s) 302 may determine the position of the first portion 310 based on the pixel information 322. The pixel information 322 may include a plurality of identifiers which indicate the pixels of the first portion 310, and the pixels of the second portion 326. It may be noted that the position of the first portion 310 may be based on the location of the image capturing device 306 located behind the display screen 308 of the display device 304, In an example, the pixel information 322 may be modified to adjust the area of the first portion 310, based on user input.

Once identified, the processor(s) 302 may then control the refresh rate of the pixels of the first portion 310 at a second refresh rate 318, while continuing to control the second portion 326 of the display screen 308 at the native refresh rate 316. The second refresh rate 318 may be such that it is less than the native refresh rate 316. With the first portion 310 being refreshed at the second refresh rate 318, the pixels of the first portion 310 may be illuminated and switched off periodically. As would be understood, when refreshed at a lower rate, the illumination of the first portion 310 will be less frequent. Since the first portion 310 when refreshed at the second refresh rate 318 illuminates less frequently, time interval between such successive illuminations may increase. As a result, the pixels of the first portion 310 may remain switched off (i.e., do not emit any light) fora longer time interval.

While the processor(s) 302 controls the refresh rate of the first portion 310, the processor(s) 302 may also generate control signals for operating the image capturing device 306. In an example, the control signals cause the image capturing device 306 to be activated between the successive illuminations of the first portion 310, when it is being refreshed at the second refresh rate 318. In an example, the image capturing device 306 may capture an image at a capture rate which matches the second refresh rate 318. For videos, the capture rate may be greater than 30 frames per second. The capture rate may be defined for any given image capturing device 306 at the time of manufacturing, and may be modified based on user preferences. It may be noted that the capture rate of the image capturing device 306 may be about 30 frames per second (or more) thereby providing an exposure time of about 30 milliseconds or less for the image capturing device 306. As explained previously, the first portion 310 being refreshed at the second refresh rate 318 affords a longer time interval between its successive illumination, and thereby results in the image capturing device 306 being active in sync with periods during which the first portion 310 is not illuminated.

In an example, the processors) 302 may control the first portion 310 such that it renders a certain number of frames from a plurality of frame(s) 320. While operating in the first mode, the first portion 310 including the second portion 326 of the display device 304 renders frame(s) 320 at the native refresh rate 316. However, in the second mode, the processor(s) 302 may cause a certain number of frames from the frame(s) 320 to be rendered. For example, if the video stream to be displayed on the display device 304 is composed of 100 frames, in the second mode the processor(s) 302 may cause the first portion 310 to render only 30 frames and not 100 frames which would have been rendered had the display device 304 been operating at the native refresh rate 316. To this end, the processor(s) 302 may cause the first portion 310 to drop corresponding portion of every alternate frame from rendering, and may then illuminate the pixels of the first portion 310 to render the relevant frames. As certain number of alternate frames are dropped from rendering, the time interval between successive illuminations increases, during which the processor(s) 302 may activate the image capturing device 306.

It may be noted that decreasing the rate at which the frames are refreshed may result in reducing the overall brightness of the pixels of the first portion 310 when operating in the second mode. Although the area of the first portion 310 is less as compared to second portion 326 of the display device 304, operating the first portion 310 at a reduced refresh rate the first portion 310 may be discernible to certain users. In an example, the processor(s) 302 may increase the time duration (referred to as a ‘hold time’) for which the pixels of the first portion 310 are to be illuminated. With the pixels of the first portion 310 being illuminated for a longer duration may compensate for any loss in brightness that may be caused due to the first portion 310 being operated at the second refresh rate 318. The manner in which the loss in brightness may be compensated may vary. For example, the processor(s) 302 may alternatively control input supply current to the pixels of the first portion 310. In such a case, the processor(s) 302 may change an input supply current to increase it from a first value to a higher second value which may be then provided to the pixels of the first portion 310. Owing to a higher value of input supply current, the pixels may illuminate with a greater intensity to compensate for any loss in brightness while the first portion 310 is operated at the second refresh rate 318.

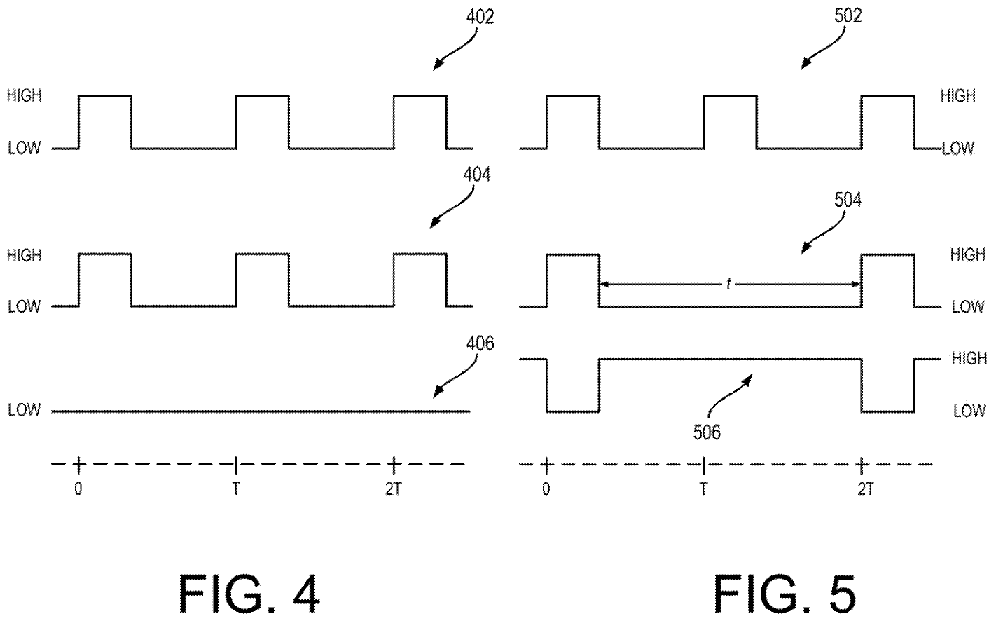

The manner in which the processor(s) 302 controls the refresh rate of the first portion 310 and the second portion 326 of the display screen 308 is further explained in conjunction with FIGS. 4-5. FIG. 4 illustrates a state diagram depicting states of the first portion 310 and the second portion 326. For example, the signal 402, 404 depicts the states of the display device 304, including the first portion 310, when the display device 304 is being operated in the first mode, as explained in conjunction with an example above. As may be observed, the signals 402, 404 alternates between high states (representative of illuminated pixels) and low states (switched off pixels) when the display device 304 is refreshed at the native refresh rate 316. During the first mode, the image capturing device 306 remains inactive as depicted by the low signal 406.

FIG. 5 illustrates the states of the pixels in the first portion 310 and the pixels in the second portion 326 of the display screen 308, as per one example. In an example, the processor(s) 302 operates the first portion 310 and the second portion 326 at different refresh rate. The rate at which the first portion 310 is refreshed (i.e., the second refresh rate 318) is less than the rate at which the second portion 326 is refreshed. This results in the first portion 310 being refreshed less frequently when compared to the second portion 326. The different states of the pixels of the first portion 310 and the second portion 326 of the display device 304 are depicted in FIG. 5. For example, the signal 502 depicts the states of the pixels of the portion other than the first portion 310. As may be observed, the signal alternates between high states (representative of illuminated pixels) and low states (switched off pixels) when the display device 304 is refreshed at the native refresh rate 316, i.e., every ‘T’ seconds. On the other hand, the pixels of the first portion 310, which are refreshed at a second refresh rate 318 (which lower than the native refresh rate 316) refreshes at instants which occur after time intervals which are greater than T seconds, in the example as illustrated and represented as signal 504. Consequently, the time interval between successive illumination of the first portion 310 occurs at a prolonged time interval depicted as ‘t’, which is longer than the time interval between successive illuminations of the second portion 326.

The processor(s) 302 may then control the image capturing device 306 such that the image capturing device 306 may capture images during the time interval when the first portion 310 is not illuminated. The state of the image capturing device 306 is depicted as signal 506. In the present example, the image capturing device 306 may be activated to capture images during the time interval t. Since the time interval between successive illuminations of the first portion 310 is longer, the image capturing device 306 may capture images without any interference from the surrounding pixels of the first portion 310.

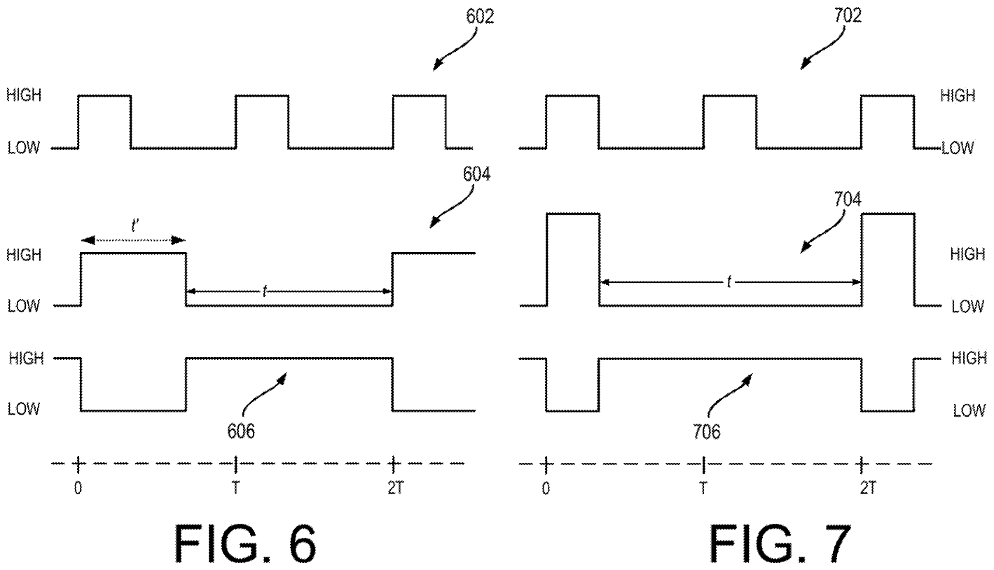

FIG. 6-7 illustrates the states of the pixels in the first portion 310 and the pixels in the second portion 326 of the display screen 308 in the second mode, as per another example, when the processor(s) 302 operates the first portion 310 and the second portion 326 at different refresh rates. The rate at which the first portion 310 is refreshed (i.e., the second refresh rate 318) is less than the rate at which the second portion 326 is refreshed. As discussed, operating the first portion 310 at a reduced refresh rate, e g , the second refresh rate 318, may result in an overall decrease in brightness of the pixels corresponding to the first portion 310. To compensate such a resultant decrease in brightness, the time duration for which the first portion is illuminated may be increased. The present example is explained in conjunction with FIG. 6, which depicts the different states of the pixels of the second portion 326 and the first portion 310 of the display device 304, through signals 602 and 604, respectively. In the present example, the signal 602 depicts the states of the pixels of the portion other than the first portion 310. As may be observed, the signal alternates between high states (representative of illuminated pixels) and low states (switched off pixels) when the display device 304 is refreshed at the native refresh rate 316, i.e., every ‘T’ seconds. On the other hand, the pixels of the first portion 310, which are refreshed at a second refresh rate 318 (which lower than the native refresh rate 316) refreshes at instants which occur at time intervals which greater than T seconds, in the example as illustrated and represented as signal 604, However, as illustrated in FIG. 6, the pixels of the first portion are illuminated for a longer duration, depicted as t′, when compared to the duration for which the pixels of the second portion 326 are illuminated, In an alternative embodiment as illustrated in FIG. 7, the processor(s) 302 may increase the input supply current to a higher value to the pixels of the first portion 310 (depicted as signal 704) when compared to the input current applied to the pixels of the second portion 326. Owing to a higher value of input supply current, the pixels may illuminate with a greater intensity to compensate for any loss in brightness while the first portion 310 is operated at the second refresh rate 318. The states of the pixels of the second portion 326 is depicted through signal 702 in FIG. 7. In the embodiments illustrated in FIGS. 6 and 7, the states of the image capturing device 306 which may be activated to capture images during the time interval t when the first portion 310 is not illuminated, are depicted as signals 606 and 706.

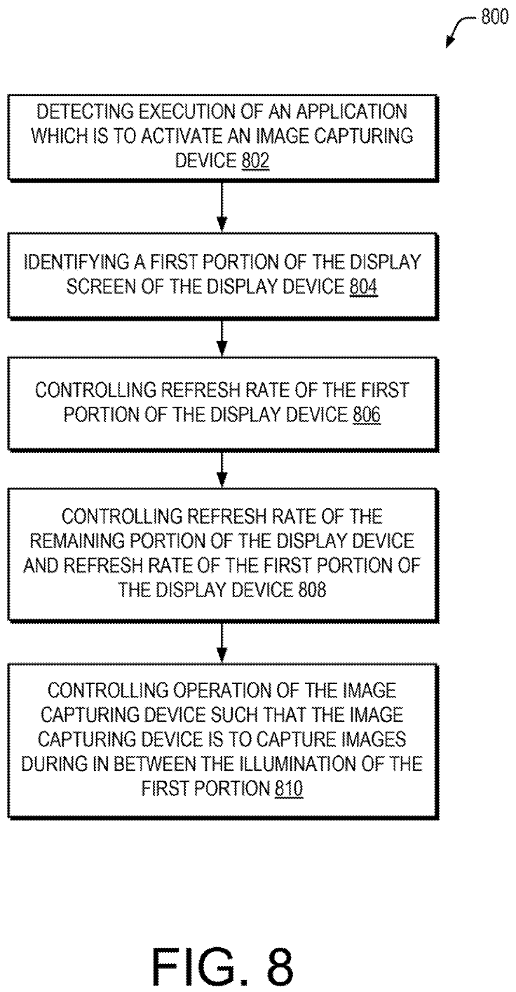

FIG. 8 illustrates a method 800 for controlling refresh rate of different portions. i.e., a first portion and a second portion, of the display device 304. Although the method 800 may be implemented in a variety of computing devices, for the ease of explanation, the present description of the example method 800 is provided in reference to the above-described computing devices 100 or 300 or display device 200.

The order in which the method 800 is described is not intended to be construed as a limitation, and any number of the described method blocks may be combined in any order to implement the method 800, or an alternative method. It may be understood that blocks of the method 800 may be performed by the computing devices 100 or 300 or by the display device 200. The blocks of the method 800 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

At block 802, execution of an application which is to activate an image capturing device is detected. For example, the processor(s) 302 may detect the execution of the certain types of applications which may in turn utilize the image capturing device 306. Examples of such applications include, but are not limited to, network-based conferencing applications, e.g., a video chat or a video conference. In response to execution of such applications, the processor(s) 302 may cause activation of the image capturing device 306.

At block 804, a first portion of the display screen of the display device may be identified. For example, the processor(s) 302 may determine the position of the first portion 310 based on pixel information 322. The pixel information 322 may include a plurality of identifiers which indicate the pixels of the first portion 310, and the pixels of the second portion 326. The position of the first portion 310 may be so defined such that it corresponds to the location of the image capturing device 306 behind the display screen 308.

At block 806, a refresh rate of the first portion of the display device may be controlled. For example, the processor(s) 302 may obtain a value of the second refresh rate 318 from the memory 314 of the computing device 300. Based on the second refresh rate 318, the processor(s) 302 may generate one or more control signals for controlling the refresh rate of the first portion 310. In an example, the second refresh rate 318 is less than native refresh rate 316 of the display device 304. To control the refresh rate of the first portion 310, the processor(s) 302 is to periodically illuminate pixels of the first portion 310 for a predefined duration followed by a period during which the first portion 310 is switched off. The rate at which the illumination of the first portion 310 occurs is based on the second refresh rate 318.

At block 808, refresh rate of the remaining portion of the display device may be controlled. For example, the processor(s) 302 may generate one or more control signals for controlling the refresh rate of the remaining portion of the display device 304, or the second portion 326, using the native refresh rate 316. To this end, the processor(s) 302 is to periodically illuminate pixels of the first portion 310 for a predefined duration followed by a period during which the first portion 310 is switched off. The rate at which the illumination of the first portion 310 occurs is based on the native refresh rate 316.

At block 810, operation of the image capturing device may be controlled such that the image capturing device is to capture images during in between the illumination of the first portion. For example, while the processor(s) 302 the refresh rate of the first portion 310 is controlled, the processor(s) 302 may also control the operation of the image capturing device 306 using one or more control signals. The control signals generated by the processor(s) 302 may cause the image capturing device 306 to be activated between the successive illuminations of the first portion 310, when it is being refreshed at the second refresh rate 318. In an example, a capture rate of the image capturing device 306 may be such that it corresponds to a second refresh rate 318 of the first portion 310. Since the first portion 310 is being refreshed at the second refresh rate 318, it affords a longer time interval between its successive illumination, and thereby results in the image capturing device 306 being active in sync with periods during which the first portion 310 is not illuminated.

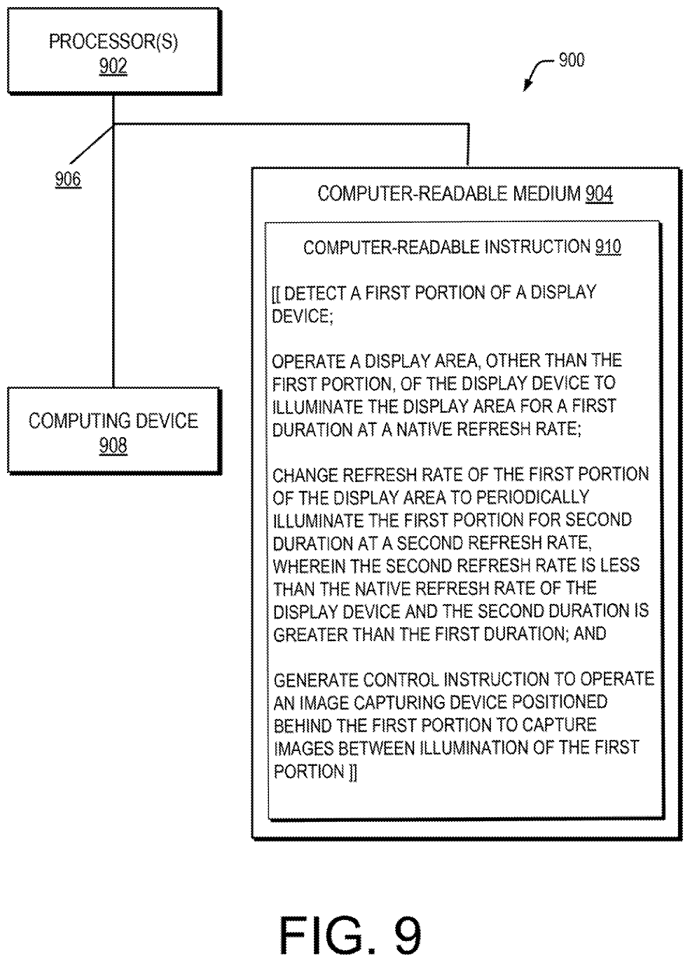

FIG. 9 illustrates a computing environment 900 implementing a non-transitory computer readable medium for generating a common video signal for an integrated graphical processing unit and for a graphical processing device. In an example, the computing environment 900 includes processor(s) 02 communicatively coupled to a non-transitory computer readable medium 904 through a communication link 906. In an example implementation, the computing environment 900 may be for a computing environment comprising computing devices 100, 300, as illustrated in FIGS. 1 and 3 or a display device 200 as depicted in FIG. 2. In an example, the processors) 902 may have one or more processing resources for fetching and executing computer-readable instructions from the non-transitory computer readable medium 904. The processor(s) 902 and the non-transitory computer readable medium 904 may be implemented, for example, in devices 100, 200 or 300.

The non-transitory computer readable medium 904 may be, for example, an internal memory device or an external memory device. In an example implementation, the communication link 906 may be a network communication link, or other communication links. The processor(s) 902 and the non-transitory computer readable medium 904 may also be communicatively coupled to a computing device 908 over the network. The computing device 908 may be implemented, for example, as computing device 300.

In an example implementation, the non-transitory computer readable medium 904 includes a set of computer readable instructions 910 which may be accessed by the processor(s) 902 through the communication link 906 and subsequently executed to implement the present subject matter. Referring to FIG. 9, in an example, the non-transitory computer readable medium 904 includes instructions 910 that cause the processor(s) 902 to detect a first portion, such as the first portion 310, of a display device, such as the display device 304. Once the first portion 310 is detected, the instructions 910 may cause the processor(s) 302 to operate a portion other than the first portion 310 of the display device 304 at a native refresh rate, such as the native refresh rate 316. While operating at the native refresh rate 316, the second portion 326 is illuminated with the successive illuminations occurring at a native rate.

The instructions 910 may also result in changing the refresh rate of the first portion, i.e., the first portion 310 such that the first portion periodically is to illuminate periodically at a second rate. The second rate, i.e., the second refresh rate 318 may be less than the native refresh rate 316 of the display device 304. Furthermore, the first portion 310 may be illuminated for a second duration which is greater than a first duration for which the second portion 326 is illuminated. Thereafter, the instructions 910 may result in generation of control instruction to operate an image capturing device, such as the image capturing device 306, located behind the first portion 310, to capture images between illumination of the first portion 310. In an example, the image capturing device 306 the instructions 910 may cause the image capturing device 306 to capture the images based on a rate which corresponds to the second refresh rate 318.

Although examples for the present disclosure have been described in language specific to structural features and/or methods, it should be understood that the appended claims are not necessarily limited to the specific features or methods described. Rather, the specific features and methods are disclosed and explained as examples of the present disclosure.

We claim:

1. A computing device comprising:
a display device having a display area, wherein the display device is to periodically illuminate at a native refresh rate;
an image capturing device positioned behind a first portion of the display area;
a processor coupled to the display device and the image capturing device, wherein the processor is to:
control a refresh rate of the first portion of the display area to periodically illuminate the first portion at a second refresh rate, wherein the second refresh rate is less than the native refresh rate; and
control operation of the image capturing device to capture images between illumination of the first portion.

2. The computing device as claimed in claim 1, wherein the processor is to refresh a second portion of the display device at the native refresh rate, wherein the second portion is a portion of the display device other than the first portion.

3. The computing device as claimed in claim 1, wherein the processor is to display certain frames from a plurality of frames while periodically illuminating the first portion at the second refresh rate.

4. The computing device as claimed in claim 1, wherein the processor is to:
determine a first duration for which the first portion is illuminated; and
modify a duration for which the first portion is illuminated to a second duration, wherein the second duration is greater than the first duration.

5. The computing device as claimed in claim 1, wherein the processor s to change an input supply current to the first portion from a first value to a second value while refreshing the first portion at the second refresh rate, wherein the second value is greater than the first value,

6. The computing device as claimed in claim 1, wherein the processor is to control the refresh rate of the first portion by delaying rendering of frames onto the first portion.

7. The computing device as claimed in claim 1, wherein the processor is to control the refresh rate of the first portion on initiation of an application that utilizes the image capturing device.

8. The computing device as claimed in claim 7, wherein the processor is to refresh the first portion and the second portion of the display device at the native refresh rate when the application that utilizes the image capturing device is not initiated.

9. A display device comprising:
a display screen of the display device, wherein the display screen is to periodically illuminate for a first duration;
an image capturing device positioned behind a first portion of the display screen;
a processor coupled to the display screen and the mage capturing device; wherein the processor is to:
control a refresh rate of the first portion to illuminate the first portion to display a certain number of frames from amongst a plurality of frames for displaying; and
control operation of the image capturing device to capture images between illumination of the first portion.

10. The display device as claimed in claim 9, wherein the processor to control the refresh rate of the first portion is to further:
identify pixels present within the first portion of the display screen; and
generate control signals to operate the identified pixels of the first portion to render certain number of frames from amongst the plurality of frames.

11. The display device as claimed in claim 9, wherein the processor is to further control the first portion to illuminate the first portion to drop alternate frames from amongst the plurality of frames.

12. The display device as claimed in claim 9, wherein the processor is to control the refresh rate of the first portion on initiation of an application that is to utilize the image capturing device.

13. A non-transitory computer-readable medium comprising computer-readable instructions, which when executed by a processor, causes a computing device to:
detect a first portion of a display device;
operate a display area, other than the first portion, of the display device to illuminate the display area for a first duration at a native refresh rate;
change refresh rate of the first portion of the display area to periodically illuminate the first portion for second duration at a second refresh rate, wherein the second refresh rate is less than the native refresh rate of the display device and the second duration is greater than the first duration; and
generate control instruction to operate an image capturing device positioned behind the first portion, to capture images between illumination of the first portion.

14. The non-transitory computer-readable medium as claimed in claim 13, wherein the first portion is detected on initiation of an application that utilizes the image capturing device.

15. The non-transitory computer-readable medium as claimed in claim 13, where the image capturing device is to capture images between illumination of the first portion at a capture rate, wherein the capture rate corresponds to the second refresh rate.
